(19) United States
(12) Patent Application Publication
(10) Pub. No.: US 2015/0213430 A1
(43) Pub. Date: Jul. 30, 2015

(54) POS TERMINAL APPARATUS AND OBJECT RECOGNITION METHOD

(71) Applicant: Toshiba Tec Kabushiki Kaisha, Tokyo (JP)

(72) Inventor: Naomi Nakane, Kanagawa-ken (JP)

(73) Assignee: Toshiba Tec Kabushiki Kaisha, Tokyo (JP)

(21) Appl. No.: 14/165,892

(22) Filed: Jan. 28, 2014

(51) Int. Cl. G06Q 20/20

(52) U.S. Cl. CPC G06Q 20/208

(57) ABSTRACT

A POS terminal apparatus according to an embodiment includes an interface and a control unit. The interface receives image data obtained by picking up an image of a commodity and a hand that is gripping the commodity. The control unit extracts a feature value of an object image present in the image data, compares the feature value and a feature value of the hand registered beforehand, and, if the feature values are not similar, compares the feature value of the object image and feature values of a plurality of commodities registered beforehand.

### FIELD

Embodiments described herein relate generally to a technique employing an image recognition technique.

### BACKGROUND

A POS (Point of sale) terminal apparatus used in a supermarket or the like instantaneously reads commodity information from barcodes or the like of commodities, which are held over a scanner one by one, to attain an increase in speed of checkout processing.

A POS terminal apparatus in the past reads barcodes or the like individually stuck to commodities using a dedicated scanner to perform checkout processing. However, it may be difficult to directly stick barcodes or the like to perishable foods such as vegetables and fruits. Therefore, an operator selects candidates of barcodes displayed on a cashier and inputs the candidates. As a result, efficiency of checkout is deteriorated.

To solve such a problem, in recent years, a POS terminal apparatus employing an object recognition technique has also been developed. The POS terminal apparatus calculates feature values of a target commodity directly held over a scanner, compares the feature values with a dictionary file created in advance, and recognizes the target commodity.

However, when the operator holds the target commodity over the scanner, since the operator holds the target commodity by hand and scans the target commodity, an image of the hand lies on the target commodity and a recognition rate of the target commodity falls.

### DESCRIPTION OF THE DRAWINGS

FIG. 1 is a perspective view showing a checkout system in an embodiment;

FIG. 2 is a block diagram showing a hardware configuration example of a POS terminal and a commodity reading apparatus;

FIG. 3A is a diagram showing an example of a FLU file of commodities;

FIG. 3B is a diagram showing an example of a file in which feature values of hands of persons in charge are stored;

FIG. 4 is a flowchart for explaining an operation example performed when feature values of a hand are recorded in the file;

FIG. 5 is a display example of an input operation guide for a hand;

FIGS. 6A and 6B are flowcharts for explaining a procedure of commodity recognition processing;

FIG. 7 is a diagram showing a state in which an operator holds a commodity in a hand and reads the commodity; and

FIG. 8 is a selection screen example of candidate commodities.

### DETAILED DESCRIPTION

A POS terminal apparatus according to an embodiment includes an interface and a control unit. The interface receives image data obtained by picking up an image of a commodity and a hand that is gripping the commodity. The control unit extracts a feature value of an object image present in the image data, compares the feature value and a feature value of the hand registered beforehand, and, if the feature values are not similar, compares the feature value of the object image and feature values of a plurality of commodities registered beforehand.

In the embodiment, in order to distinguish a commodity and a hand in a POS terminal apparatus employing object recognition processing, feature values of a hand of an operator (a store clerk) are registered. When a store size is large, since a plurality of operators operates the POS terminal apparatus by turn, the POS terminal apparatus in the embodiment can add feature values of a hand for each of the operators.

The embodiment is explained below with reference to the drawings.

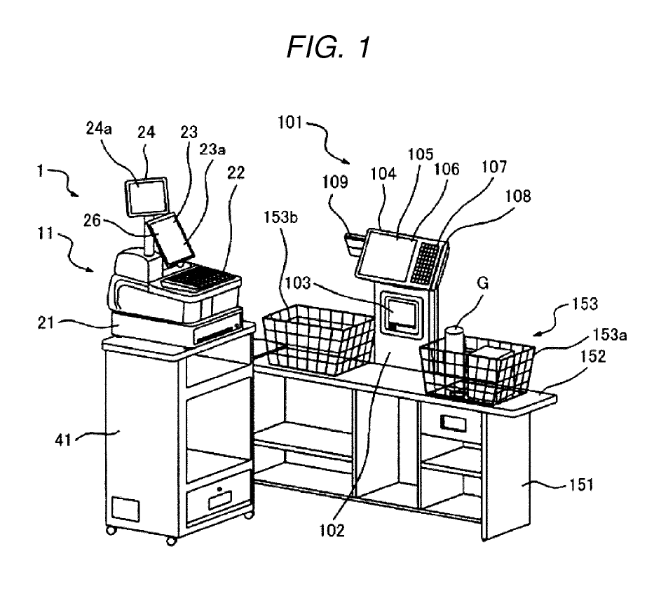

FIG. 1 is a perspective view showing an example of a checkout system. As shown in FIG. 1, a checkout system 1 includes a commodity reading apparatus 101 that reads information concerning a commodity and a POS terminal 11 that performs registration and settlement of commodities in each transaction. In the following explanation, the same components shown in a plurality of drawings are denoted by the same reference numerals and signs and redundant explanation of the components is sometimes omitted.

The POS terminal 11 is placed on the upper surface of a drawer 21 on a checkout table 41. The drawer 21 is subjected to control of an opening motion by the POS terminal 11. A keyboard 22 pressed by an operator is present on the upper surface of the POS terminal 11. A display device 23 configured to display information to the operator is present further on the depth side than the keyboard 22 viewed from the operator. The display device 23 displays the information on a display surface 23a thereof. A touch panel 26 is laminated on the display surface 23a. A display device for customer 24 is rotatably provided further on the depth side than the display device 23.

A counter table 151 having a laterally long table shape is arranged such that the counter table 151 and the checkout table 41, on which the POS terminal 11 is set, form an L shape. A loading surface 152 is present on the upper surface of the counter table 151. A shopping basket 153 for storing a commodity G is placed on the loading surface 152. The shopping basket 153 can be classified into a first shopping basket 153a carried in by a customer and a second shopping basket 153b placed in a position across the commodity reading apparatus 101 from the first shopping basket 153a. The shopping basket 153 is not limited to a so-called basket shape and may be a tray or the like. The second shopping basket 153b is not limited to a so-called basket shape and may be a box shape, a bag shape, and the like.

On the loading surface 152 of the counter table 151, the commodity reading apparatus 101 connected to the POS terminal 11 to be capable of transmitting and receiving data to and from the POS terminal 11 is set. The commodity reading apparatus 101 includes a thin rectangular housing 102. A reading widow 103 is present on the front surface of the housing 102. A display and operation unit 104 is attached to an upper part of the housing 102. In the display and operation unit 104, a display device 106 of a touch panel 105 is laminated on the surface, is provided. A keyboard 107 is disposed on the right of the display device 106. A card reading groove 108 for a card reader (not shown in the figure) is provided on the right of the keyboard 107. A display device for customer 109 for providing the customer with information is set on the left depth side on the rear surface of the display and operation unit 104 viewed from the operator.

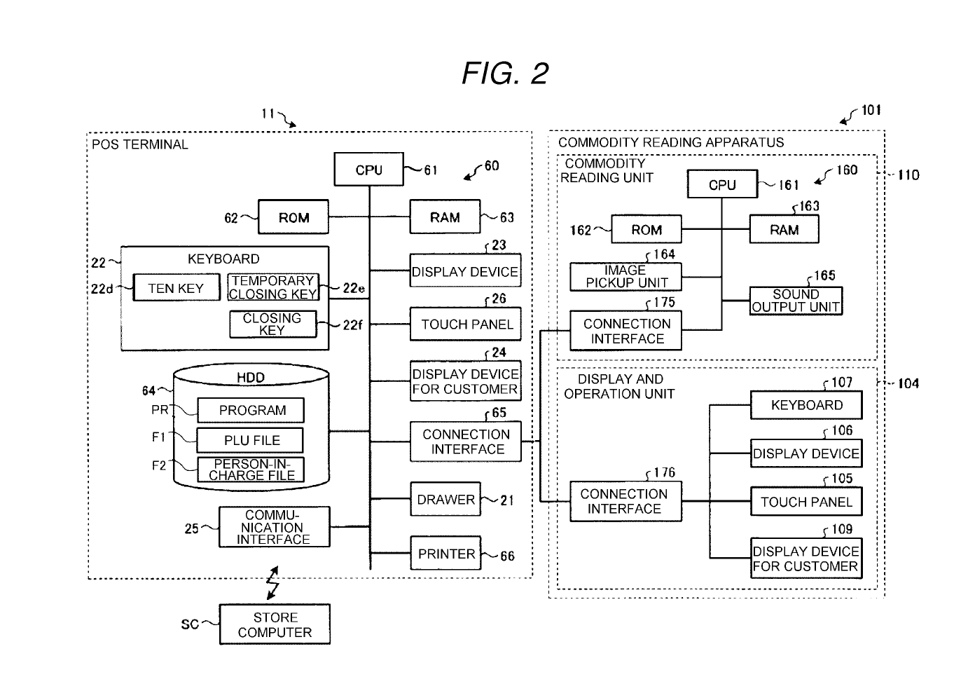

Such a commodity reading apparatus 101 includes a commodity reading unit 110 (see FIG. 2). In the commodity reading unit 110, an image pickup unit 164 (see FIG. 2) is arranged on the depth side of the reading window 103.

The commodity G is stored in the first shopping basket 153a carried in by the customer. The commodity G in the first shopping basket 153a is moved to the second shopping basket 153b by the operator who operates the commodity reading apparatus 101. In a process of the movement, the commodity G is turned to the reading window 103 of the commodity reading apparatus 101. When the commodity G is turned to the reading window 103, the image pickup unit 164 (see FIG. 2) arranged in the reading window 103 picks up an image of the commodity G.

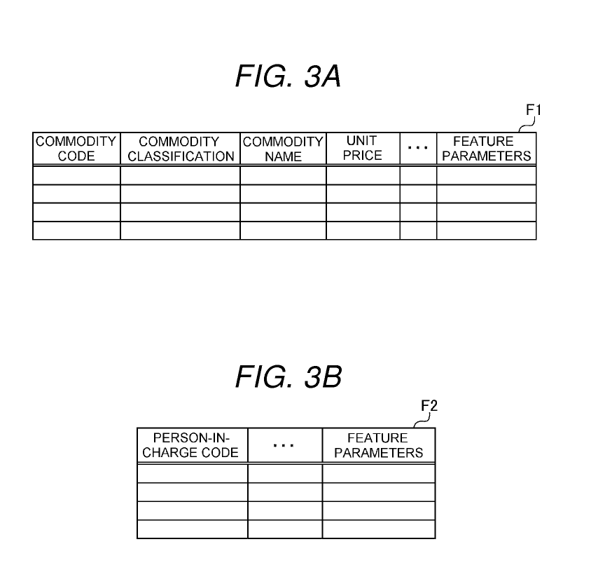

The commodity reading apparatus 101 transmits the image picked up by the image pickup unit 164 to the POS terminal 11. The POS terminal 11 determines, using image recognition processing, which commodity registered in a below-mentioned PLU file F1 (see FIG. 3A) the commodity G corresponds to. The POS terminal 11 records, on the basis of a specified commodity code, information concerning sales registration such as a commodity classification, a commodity name, and a unit price corresponding to the commodity code in a sales master file (not shown in the figure) or the like and performs the sales registration.

FIG. 2 is a block diagram showing a hardware configuration example of the POS terminal 11 and the commodity reading apparatus 101. As shown in FIG. 2, the POS terminal 11, the commodity reading unit 110 of the commodity reading apparatus 101, and the display and operation unit 104 can transmit and receive data to and from one another through connection interfaces 65, 175, and 176.

The POS terminal 11 includes a microcomputer 60 (a control unit) configured to execute information processing. The microcomputer 60 includes a configuration in which a ROM (Read Only Memory) 62 and a RAM (Random Access Memory) 63 are connected to a CPU (Central Processing Unit) 61, which is a processor configured to execute various kinds of arithmetic processing and control various units, by a bus.

The CPU 61 of the POS terminal 11 is connected to the drawer 21, the keyboard 22, the display device 23, the touch panel 26, and the display device for customer 24 via various input and output circuits (all of which are not shown in the figure). The drawer 21, the keyboard 22, the display device 23, the touch panel 26, and the display device for customer 24 are controlled by the CPU 61.

The keyboard 22 includes a ten key 22d, on the upper surface of which numbers such as “1”, “2”, and “3” and signs such as a multiplication operator are displayed, a temporary closing key 22e, and a closing key 22f.

The CPU 61 of the POS terminal 11 is connected to a HDD 64 (Hard Disk Drive). Computer programs and various files are stored in the HDD 64. When the POS terminal 11 is started, all or a part of the computer programs and the various files stored in the HDD 64 are copied to the RAM 63 and executed by the CPU 61. Consequently, the microcomputer 60 controls respective kinds of hardware in the POS terminal 11. An example of the computer programs stored in the HDD 64 is a computer program PR for commodity sales data processing. Examples of the files stored in the HDD 64 are the PLU file F1 and a below-mentioned person-in-charge file F2 (see FIG. 3B) distributed from a store computer SC via a communication interface 25 and stored in the HDD 64.

The POS terminal 11 includes a printer 66. The printer 66 prints a receipt after checkout processing concerning purchased commodities is performed.

The commodity reading unit 110 of the commodity reading apparatus 101 includes a microcomputer 160 configured to execute information processing. The microcomputer 160 includes a configuration in which a ROM 162 and a RAM 163 are connected to a CPU 161 by a bus. The CPU 161 expands a computer program (e.g., a computer program for image pickup) stored in the ROM 162 on the RAM 163 and executes an arithmetic operation. Consequently, the microcomputer 160 controls respective kinds of hardware in the commodity reading apparatus 101. The commodity reading unit 110 includes a sound output unit 165 configured to output reading confirmation sound when the commodity reading unit 110 reads a commodity.

As explained above, the operator holds commodities in the first shopping basket 153a over the reading window 103 one by one. The commodity reading apparatus 101 outputs an image picked up by the image pickup unit 164 to the POS terminal 11. When an image of the commodity is not correctly pickup up or when an image of a hand holding the commodity is picked up over a wide area, the POS terminal 11 displays a message such as “Please input a commodity again” on the display device 23 in order to urge the operator to pick up an image again.

A data configuration example of the PLU file is shown in FIG. 3A. The PLU file F1 is a file in which, concerning each of commodities displayed and sold in a store, association between information concerning sales registration of the commodity and an image of the commodity is set. The PLU file F1 includes information concerning a commodity code uniquely allocated to each of the commodities, a commodity classification to which the commodity belongs, a commodity name, and a unit price. The PLU file F1 includes feature values (feature parameters) of the commodity or a path name of a commodity image obtained by picking up an image of the commodity.

The HDD 64 has stored therein a person-in-charge file F2, which is information concerning persons in charge (operators of the POS terminal). Data written in the person-in-charge file F2 is shown in FIG. 3B. The person-in-charge file F2 is a file in which a person-in-charge code uniquely allocated to each of the persons in charge and feature values (feature parameters) of a hand of the person in charge or a path name of an image file obtained by picking up an image of the hand are stored. Besides, information such as a person-in-charge name and a department code may be stored.

The HDD 64 includes threshold information called “similarity: 0.XX”. The threshold called “similarity: 0.XX” makes it possible to determine, when commodities have similar feature values like apples of different kinds, to which of commodity images stored in a PLU file in advance the commodities are close by comparing the commodities with the commodity images. The HDD 64 also includes threshold information concerning hands of the persons in charge.

The operations of the POS terminal 11 and the commodity reading apparatus 101 are explained.

The CPU 161 of the commodity reading apparatus 101 outputs a video ON signal to the image pickup unit 164 and causes the image pickup unit 164 to start an image pickup operation. The CPU 161 sequentially captures frame images picked up by the image pickup unit 164 and stored in the RAM 163 after the image pickup operation is started. The capturing of the frame images by the CPU 161 is performed in the order of storage in the RAM 163. If some object is captured into a frame image, the CPU 161 outputs the frame image to the POS terminal 11 via the connection interface 175. The determination concerning whether an object is captured into a frame image is performed by, for example, comparing a contour line extracted from an immediately preceding frame image and a contour line extracted from the present frame image.

The CPU 61 of the POS terminal 11 extracts the object from the frame image into which the object is captured. Specifically, the CPU 61 extracts a contour line or the like from an image obtained by binarizing the frame image. When the operator detects a commodity, since the operator holds the commodity by a hand and holds the commodity over the reading window, it is highly likely that the hand is reflected on a frame image. Therefore, feature values of the hand are registered in the person-in-charge file F2 in advance and the CPU 61 detects a skin color portion or the like from the frame image on which the hand is reflected, calculates feature values of the skin color portion, and compares the feature values with the feature values registered in the person-in-charge file F2. A result of the comparison is calculated as similarity. If the similarity exceeds the threshold, the CPU 61 determines that the “hand” is input and displays a message such as “Please input the commodity again” on the display device 23.

The feature values of the hands are sometimes different among the operators. Therefore, plurality images of the hand are input in advance for each of the operators (store clerks). The feature values of the hand of each of the operators are registered in the person-in-charge file F2 in advance. An example of this operation is explained below.

The CPU 61 of the POS terminal 11 refers to the PLU file F1 and reads, from an image of all or a part of a commodity subjected to image pickup by the image pickup unit 164 of the image reading apparatus 101, states of the surface of the commodity such as a tint and an unevenness state of the surface as feature values to thereby recognize the commodity as a specific object. The POS terminal 11 can specify, according to a recognition result of the CPU 61, the commodity read by the commodity reading apparatus 101 out of the commodities registered in the PLU file F1 in advance.

The CPU 61 calculates similarity concerning the recognized hand and the recognized commodity and determines whether the similarity exceeds the threshold set in advance. Recognizing an object included in an image in this way is called generic object recognition. The conventional technique of such generic object recognition may be utilized in the embodiment. There is also known a technique for performing the generic object recognition by segmenting an image for each of objects.

The CPU 61 records information concerning sales registration related to a recognized commodity image in the sales master file or the like and performs the sales registration. The information concerning the sales registration is, in this embodiment, a commodity code, a commodity classification, a commodity name, a unit price, and the like of a commodity specified as a commodity read by the commodity reading apparatus 101.

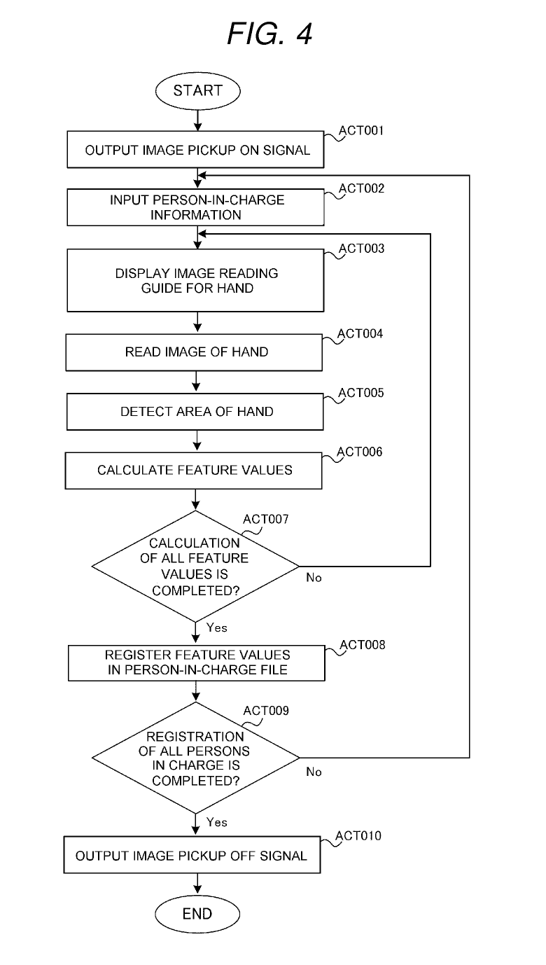

FIG. 4 is a flowchart for explaining an operation example for adding feature values to the person-in-charge file F2.

When a signal for starting rewriting processing for the person-in-charge file F2 is input from the POS terminal 11, the CPU 161 outputs an image pickup ON signal to the image pickup unit 164 and starts image pickup (ACT 001). First, in order to input information such as a name of a person in charge and a person-in-charge code, the operator inputs barcode information written on an employee name card from the image pickup unit 164 (ACT 002).

Subsequently, the operator inputs an image of a hand of the person in charge from the image pickup unit 164. Since kind of plurality hand images are necessary, the CPU 161 displays an input guide on the display device 106 of the display and operation unit 104. The operator inputs an image of the hand according to a procedure of the input guide (ACT 003).

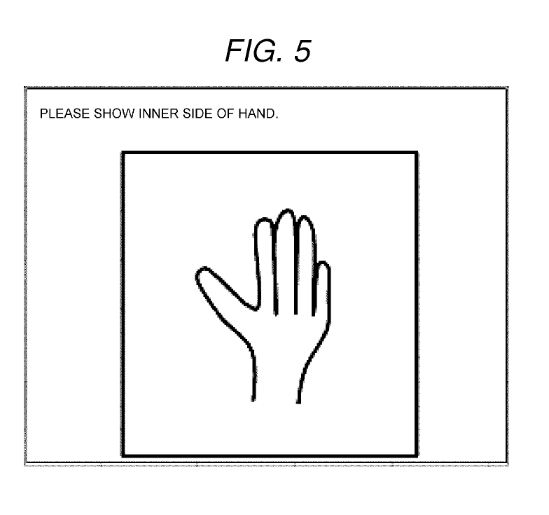

An example of the input guide for the hand is shown in FIG. 5. The image of the hand input from the image pickup unit 164 according to the input guide is temporarily stored in, for example, the RAM 63 of the POS terminal 11.

The CPU 61 of the POS terminal 11 detects the image of the hand (ACT 004). Specifically, the CPU 61 performs skin color detection in order to separate a background image and the hand from a captured frame image and extracts an area of the hand (ACT 005). When the area of the hand is extracted, the CPU 61 calculates feature values such as a contour, a tint, and an unevenness state of the surface of the hand (ACT 006).

If the image is insufficient for the feature value calculation or if feature values are not extracted concerning all directions of the hand defined beforehand (ACT 007, No), the display device 106 displays the input guide for the hand again (returns to ACT 003). In this way, the CPU 61 repeatedly carries out the area detection and the feature value calculation for the hand by changing the direction of the hand.

If all feature values of the hand are calculated (ACT 007, Yes), the CPU 61 additionally registers the feature values in the person-in-charge file F2 in association with a person-in-charge code (ACT 008). If plurality operators are present, the CPU 161 and the CPU 61 repeatedly perform these procedures for the respective operators (ACT 009, a loop of No). If the processing is completed for the respective operators (ACT 009, Yes), the CPU 161 outputs an image pickup OFF signal to the image pickup unit 164 (ACT 010) and the processing ends.

The operation shown in FIG. 4 is performed at any time, for example, when an operator is added.

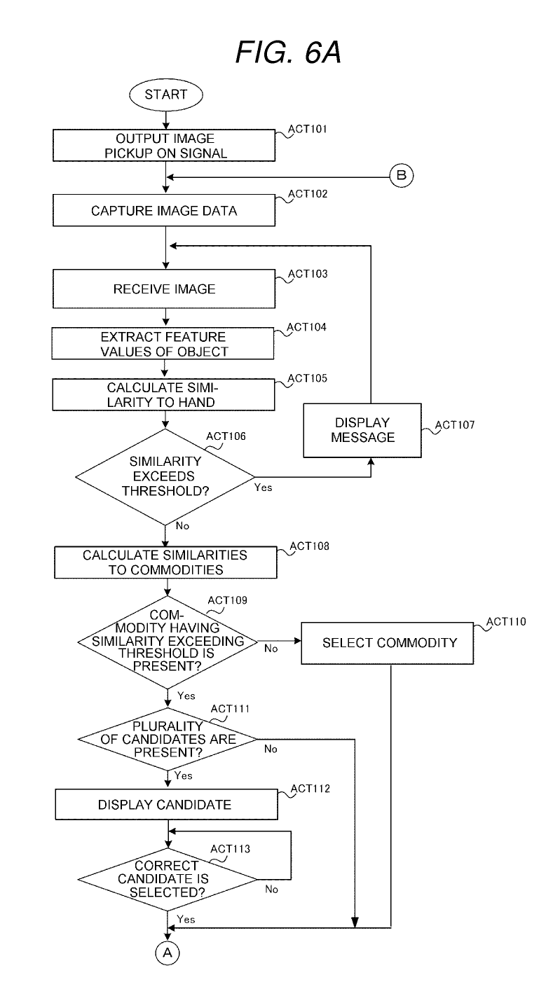

FIGS. 6A and 6B are flowcharts for explaining a procedure of commodity recognition processing in the embodiment. When the processing is started according to the start of commodity registration by the POS terminal 11, the CPU 161 outputs an ON signal to the image pickup unit 164 (ACT 101) and starts image pickup by the image pickup unit 164. Subsequently, the CPU 161 performs detection of a commodity from a captured frame image and outputs an image to the POS terminal 11 (ACT 102).

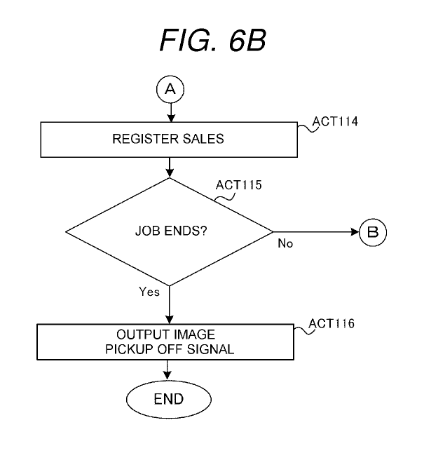

The connection interface 65 of the POS terminal 11 receives the image from the image reading apparatus 101 according to an instruction received from the CPU 61 (Act 103). The image is image data obtained by picking up images of a commodity and a hand that is gripping the commodity. The CPU 61 extracts feature values of an object image present in the image (ACT 104). Objects are the commodity and the hand that is gripping the commodity. In the image, for example, as shown in FIG. 7, the hand and the commodity are integrated and the hand lies on the commodity. The CPU 61 extracts a contour, a tint, an unevenness state of the surface, and the like of the object image as feature values.

The CPU 61 refers to the person-in-charge file F2, compares feature values (feature parameters) of the hand of the operator and feature values of the objects reflected on the image, and calculates similarity (ACT 105). It is determined at this point according to authentication processing or the like in advance which of the operators is currently operating the POS terminal 11. The similarity indicates, when the similarity of the image of the hand of each of the operators stored in the operator file F2 is assumed to be 100%=“similarity: 1.0”, to which degree the object image output from the commodity reading apparatus 101 is similar to the image. The similarity is calculated according to states of the surface such as the contour, the tint, and the unevenness state of the surface. In the calculation of the similarity, for example, concerning the tint among the feature values, weighting may be performed considering that the tint is an important element. When the similarity exceeds the threshold (ACT 106, Yes), it is highly likely recognized that the reflected object is not the commodity but the “hand”. Therefore, the CPU 61 causes, for example, the display device 106 to display a message for urging the operator to input an image again (ACT 107). For example, when the hand lies on the commodity the commodity is not recognized as shown in FIG. 7, the recognition rate of the commodity falls. Therefore, the CPU 61 sends a message or the like to the operator and urges the operator to pick up an image again.

When the similarity to the “hand” is smaller than the threshold (ACT 106, No), the CPU 61 determines that the commodity is normally input. Subsequently, the CPU 61 calculates similarity while respectively comparing, using the PLU file F1, the feature values (the feature parameters) of the registered commodities and the feature values of the object reflected on the image (ACT 108).

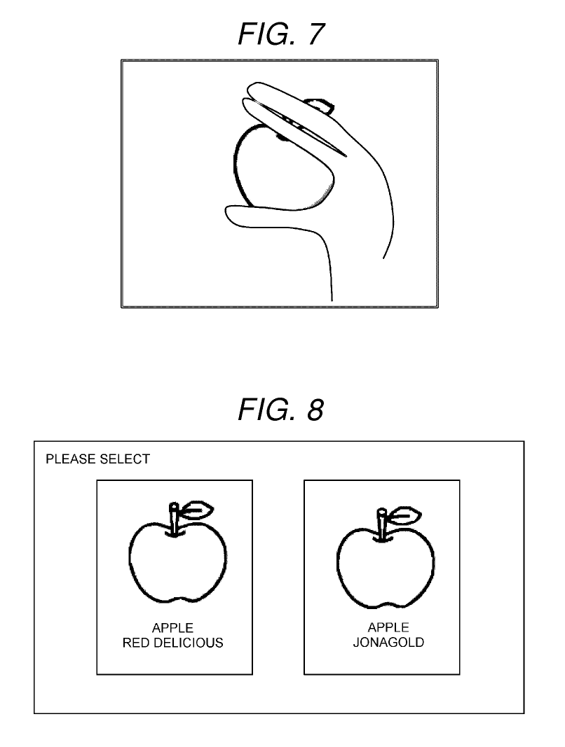

As a result of the recognition, if a commodity having similarity exceeding the threshold is absent (ACT 109, No), the CPU 61 receives commodity selection through a manual input of the operator (ACT 110) and proceeds to ACT 114. If it is determined that a commodity having similarity exceeding the threshold is present (ACT 109, Yes) and if a plurality of candidates of the commodity are preset (ACT 111, Yes), the CPU 61 causes the display device 23 (or the display device 106) to display a screen for selecting any one of the candidates (ACT 112). FIG. 8 is a diagram showing an example of the display. Product names of the plurality of candidates of the commodity are acquired from the PLU file F1 and displayed on the displayed screen.

If the CPU 61 determines that the operator selects a correct candidate via the touch panel 26 (or the touch panel 105) (ACT 113, Yes), the CPU 61 proceeds to ACT 114. If there is not a plurality of candidates of the commodity (ACT 111, No), the CPU 61 directly proceeds to ACT 114.

The CPU 61 registers a result of the commodity recognition processing and sales of the commodity selected by the operator (ACT 114).

Finally, the CPU 61 determines whether a job is ended according to the end of the sales registration instructed by the operation of the keyboard 22 (ACT 115). If the job is ended (ACT 115, Yes), the CPU 161 outputs an image pickup OFF signal and causes the image pickup unit 164 to end the image pickup (ACT 116), ends the screen display on the display device for customer 24, and completes the processing. If the job is not ended (ACT 115, No), the CPU 161 returns to ACT 102.

As explained above, the feature values of the hands of the respective operators (store clerks) are registered in advance and recognition of a hand is performed before commodity recognition. Consequently, even if the hand lies on the commodity, it is possible to notify the operator of that effect and urge the operator to perform scanning again.

In the example explained above, it is assumed that an example of the POS terminal apparatus is the POS terminal 11 and the object recognition processing is performed by the POS terminal 11. However, the object recognition processing may be performed by the commodity reading apparatus 101. In this case, the POS terminal apparatus is the commodity reading apparatus 101.

In the explanation in this embodiment, the function for carrying out the invention is recorded in the apparatus in advance. However, the same function may be downloaded from a network to the apparatus or the same function stored in a recording medium may be installed in the apparatus. A form of the recording medium may be any form as long as the recording medium is a recording medium that can store a computer program and can be read by the apparatus such as a CD-ROM. The function obtained by the installation or the download in advance in this way may be realized in cooperation with an OS (operating system) or the like provided inside the apparatus.

According to this embodiment, since recognition of a hand that is griping a commodity is performed before commodity recognition, it is possible to suppress misrecognition of the commodity due to inclusion of the hand in an image.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. A POS terminal apparatus comprising:
an interface configured to receive image data obtained by picking up an image of a commodity and a hand that is gripping the commodity; and
a control unit configured to extract a feature value of an object image present in the image data, compare the feature value and a feature value of the hand registered beforehand, and, if the feature values are not similar, compare the feature value of the object image and feature values of a plurality of commodities registered beforehand.

2. The apparatus according to claim 1, wherein, if the feature value of the object image and the feature value of the hand registered beforehand are similar, the control unit causes a display unit to display a message.

3. The apparatus according to claim 1, wherein the control unit compares the feature value of the object image and the feature values of the plurality of commodities registered beforehand and, if a plurality of similar commodities are present, causes a display unit to display information concerning the plurality of similar commodities.

4. The apparatus according to claim 1, further comprising a storing unit configured to store, in association with information concerning operators who operate the POS terminal apparatus, a plurality of feature values of hands of the operators, wherein
the control unit acquires, on the basis of the association, from the storing unit, a feature value of a hand of an operator who is currently operating the POS terminal apparatus and compares the feature value with the feature value of the object.

5. The apparatus according to claim 4, wherein
the interface further receives information concerning an operator and an image of a hand of the operator, and
the control unit extracts a feature value of the hand of the operator in the image and causes the storing unit to store the extracted feature value and the information concerning the operator in association with each other.

6. The apparatus according to claim 5, wherein the control unit causes a display unit to display a screening that indicates a direction of a hand with respect to an image pickup unit.

7. An object recognition method for a POS terminal apparatus, comprising:
receiving image data obtained by picking up an image of a commodity and a hand that is gripping the commodity;
extracting a feature value of an object image present in the image data; and
comparing the feature value and a feature value of the hand registered beforehand, and, if the feature values are not similar, comparing the feature value of the object image and feature values of a plurality of commodities registered beforehand.

8. The method according to claim 7, further comprising displaying a message if the feature value of the object image and the feature value of the hand registered beforehand are similar.

9. The method according to claim 7, further comprising comparing the feature value of the object image and the feature values of the plurality of commodities registered beforehand and, if a plurality of similar commodities are present, displaying information concerning the plurality of similar commodities.

10. The method according to claim 7, further comprising:
receiving information concerning an operator and an image of a hand of the operator;
extracting a feature value of the hand of the operator in the image and storing, in a storing unit, the extracted feature value and the information concerning the operator in association with each other; and
acquiring, on the basis of the association, from the storing unit, a feature value of a hand of an operator who is currently operating the POS terminal apparatus and comparing the feature value with the feature value of the object.
